(19) United States
(12) Patent Application Publication
(10) Pub. No.: US 2019/0111793 A1
(43) Pub. Date: Apr. 18, 2019

(54) ELECTRIC WHEELCHAIR, ASSOCIATED ELECTRIFIED VEHICLE, AND METHOD OF CHARGING AN ELECTRIC WHEELCHAIR

(71) Applicant: Ford Global Technologies, LLC, Dearborn, MI (US)

(72) Inventors: Erik J. Christen, Royal Oak, MI (US); Yang Yang, Belleville, MI (US); Mahmoud Abdelhamid, Canton, MI (US); Chad Bednar, Royal Oak, MI (US)

(21) Appl. No.: 15/782,957

(22) Filed: Oct. 13, 2017

(51) Int. Cl. B60L 11/18

(52) U.S. Cl. CPC B60L 11/1816; B60L 2210/10; B60L 2200/34

(57) ABSTRACT

A method of charging an electric wheelchair according to an exemplary aspect of the present disclosure includes, among other things, charging an energy storage device of the electric wheelchair with power from an electrified vehicle charging station. An electric wheelchair and an electrified vehicle are also disclosed.

### TECHNICAL FIELD

This disclosure relates to an electric wheelchair and an associated electrified vehicle, which in one example is a conversion van configured to transport an electric wheelchair. This disclosure also relates to a method of charging an electric wheelchair.

### BACKGROUND

Wheelchairs are chairs with wheels used by patients with injuries or illnesses that make walking difficult or impossible. Electric wheelchairs (sometimes referred to as power wheelchairs) are motorized, as opposed to self-propelled wheelchairs where a user manually drives the wheelchair. Electric wheelchairs typically include a battery configured to direct power to a motor, which in turn drives the wheelchair. As such, electric wheelchairs are often a more appropriate option for those who are physically incapable of manually propelling a wheelchair. The battery of an electric wheelchair is typically charged using a charger configured to couple to an ordinary wall-outlet.

### SUMMARY

A method of charging an electric wheelchair according to an exemplary aspect of the present disclosure includes, among other things, charging an energy storage device of the electric wheelchair with power from an electrified vehicle charging station.

In a further non-limiting embodiment of the foregoing method, the method includes plugging a plug of the electrified vehicle charging station directly into an interface of the electric wheelchair. Further, the interface is coupled to the energy storage device of the electric wheelchair.

In a further non-limiting embodiment of any of the foregoing methods, the method includes plugging a plug of another electrified vehicle charging station into an interface coupled to an energy storage device of an electrified vehicle. Further, the electric wheelchair is located within the electrified vehicle.

In a further non-limiting embodiment of any of the foregoing methods, the method further includes charging the energy storage devices of the electric wheelchair and the electrified vehicle simultaneously.

In a further non-limiting embodiment of any of the foregoing methods, the method further includes plugging a plug of the electrified vehicle charging station into an interface of an electrified vehicle, and charging the energy storage device of the electric wheelchair using power from an energy storage device of the electrified vehicle.

In a further non-limiting embodiment of any of the foregoing methods, the method further includes removing the plug of the electrified vehicle charging station from the interface of the electrified vehicle, and charging the energy storage device of the electric wheelchair using power from the energy storage device of the electrified vehicle.

In a further non-limiting embodiment of any of the foregoing methods, the electrified vehicle is a conversion van.

In a further non-limiting embodiment of any of the foregoing methods, the energy storage device of the electric wheelchair is a high voltage battery pack.

In a further non-limiting embodiment of any of the foregoing methods, the energy storage device of the electric wheelchair is a low voltage battery pack, and the electric wheelchair includes a DC-to-DC converter.

In a further non-limiting embodiment of any of the foregoing methods, the electrified vehicle charging station is publicly accessible.

In a further non-limiting embodiment of any of the foregoing methods, the electrified vehicle charging station includes a plug coupled to a terminal by a cable.

In a further non-limiting embodiment of any of the foregoing methods, the terminal is electrically coupled to an electrical grid.

An electrified vehicle according to an exemplary aspect of the present disclosure includes, among other things, an energy storage device, a first interface configured to couple the energy storage device to a plug of an electrified vehicle charging station, and a second interface configured to couple the energy storage device to an electric wheelchair.

In a further non-limiting embodiment of the foregoing electrified vehicle, the vehicle includes a wheelchair support in a rear portion of the electrified vehicle, the wheelchair support including a portion of the second interface.

In a further non-limiting embodiment of any of the foregoing electrified vehicles, the wheelchair support includes at least one of a lock and a lift.

In a further non-limiting embodiment of any of the foregoing electrified vehicles, the electrified vehicle is a conversion van.

An electric wheelchair according to an exemplary aspect of the present disclosure includes, among other things, a motor, an energy storage device configured to power the motor, and an interface configured to connect to a plug of an electrified vehicle charging station to charge the energy storage device.

In a further non-limiting embodiment of the foregoing electric wheelchair, the interface is a first interface, and the electric wheelchair includes a second interface configured to connect to an energy storage device of an electrified vehicle.

In a further non-limiting embodiment of any of the foregoing electric wheelchairs, the energy storage device includes a low voltage battery pack, and the electric wheelchair includes a DC-to-DC converter.

In a further non-limiting embodiment of any of the foregoing electric wheelchairs, the energy storage device is a high voltage battery pack.

### BRIEF DESCRIPTION OF THE DRAWINGS

FIG. 1 schematically illustrates a powertrain of an electrified vehicle.

FIG. 2 illustrates an electrified vehicle and an electric wheelchair near an electrified vehicle charging station.

FIG. 3 schematically illustrates the electrified vehicle, electric wheelchair, and electrified vehicle charging station of FIG. 2.

FIG. 4 illustrates an electric wheelchair near an electrified vehicle charging station.

FIG. 5 schematically illustrates the electric wheelchair and the electrified vehicle charging station of FIG. 4.

### DETAILED DESCRIPTION

This disclosure relates to an electric wheelchair and an associated electrified vehicle, which in one example is a conversion van configured to transport an electric wheelchair or group of electric wheelchairs. This disclosure also relates to a method of charging the electric wheelchair using power from an electrified vehicle charging station (either directly from the electrified vehicle charging station or indirectly from a battery pack of the electrified vehicle). In a method of this disclosure, an energy storage device of the electric wheelchair is charged with power from an electrified vehicle charging station. Using this disclosure, the electric wheelchair can be charged relatively quickly and efficiently even when a user is away from their ordinary charging location (e.g., home or office), which increases the ease of mobility of the wheelchair user and, in turn, increases quality of life.

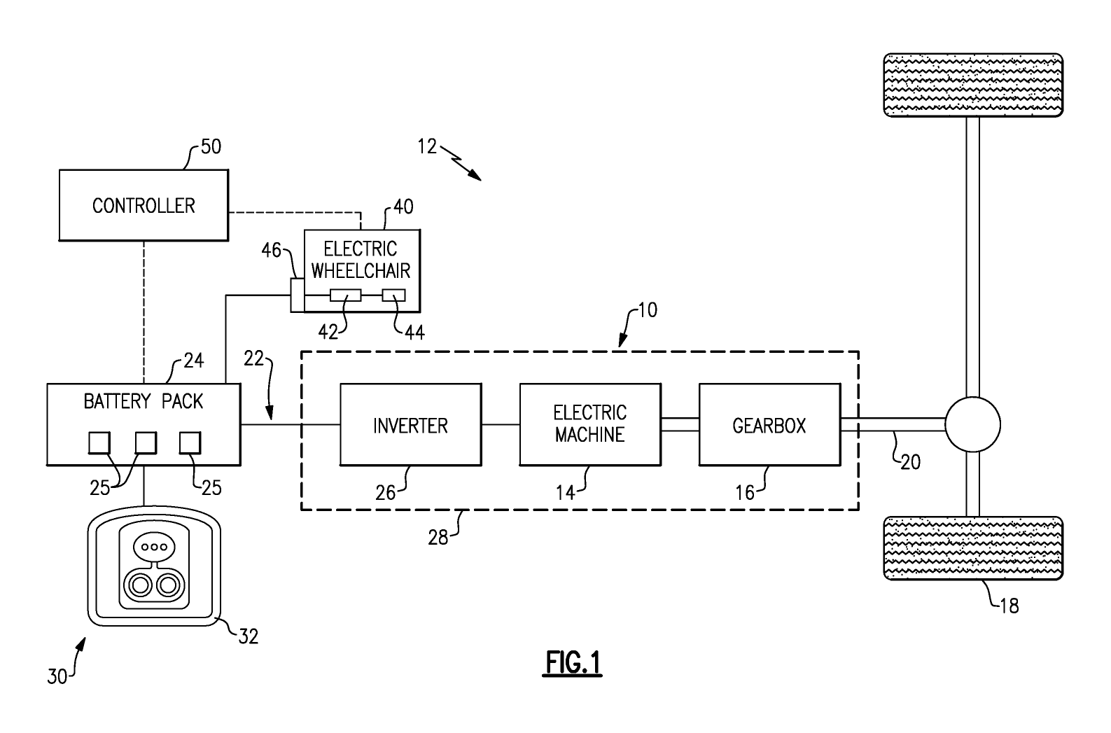

FIG. 1 schematically illustrates a powertrain 10 of an electrified vehicle 12. Although depicted as a battery electric vehicle (BEV), it should be understood that the concepts described herein are not limited to BEVs and could extend to other electrified vehicles, including but not limited to, plug-in hybrid electric vehicles (PHEVs). Therefore, although not shown in this embodiment, the electrified vehicle 12 could be equipped with an internal combustion engine that can be employed either alone or in combination with other energy sources to propel the electrified vehicle 12.

In a non-limiting embodiment, the electrified vehicle 12 is a full electric vehicle propelled solely through electric power, such as by an electric machine 14, without any assistance from an internal combustion engine. The electric machine 14 may operate as an electric motor, an electric generator, or both. The electric machine 14 receives electrical power and provides a rotational output power. The electric machine 14 may be connected to a gearbox 16 for adjusting the output torque and speed of the electric machine 14 by a predetermined gear ratio. The gearbox 16 is connected to a set of drive wheels 18 by an output shaft 20. A high voltage bus 22 electrically connects the electric machine 14 to a battery pack 24 through an inverter 26. The electric machine 14, the gearbox 16, and the inverter 26 may collectively be referred to as a transmission 28.

The battery pack 24 is an energy storage device and, in this example, is an exemplary electrified vehicle battery. The battery pack 24 may be a high voltage traction battery pack that includes a plurality of battery assemblies 25 (i.e., battery arrays or groupings of battery cells) capable of outputting electrical power to operate the electric machine 14 and/or other electrical loads of the electrified vehicle 12. Other types of energy storage devices and/or output devices can also be used to electrically power the electrified vehicle 12.

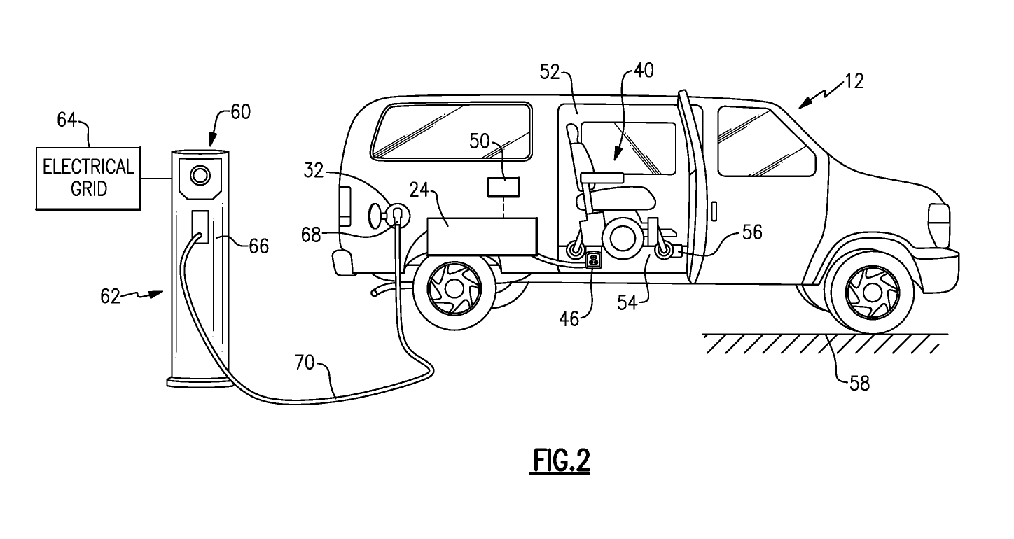

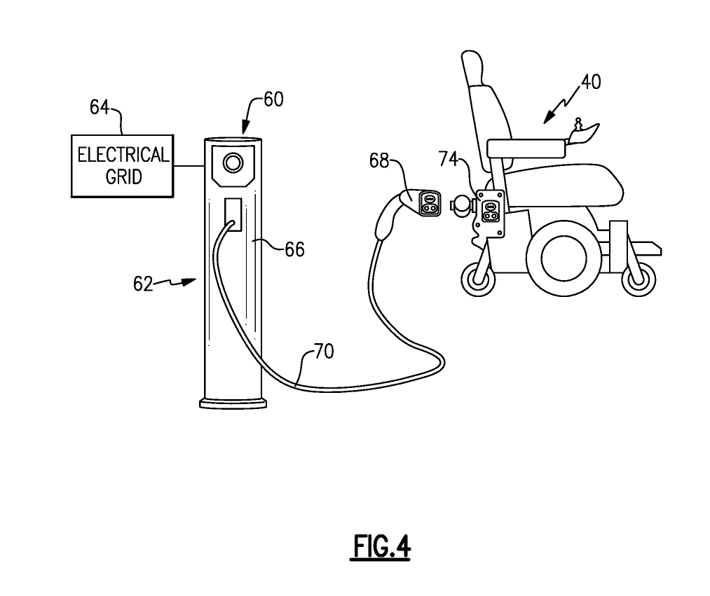

The electrified vehicle 12 may also include a charging system 30 for periodically charging the cells of the battery pack 24. The charging system 30 may be connected to an external power source, such as an electrical grid 64 (FIGS. 2, 4), for receiving and distributing power to the cells. For example, in one non-limiting embodiment, the charging system 30 includes a first interface 32, which is a charging port, located on-board the electrified vehicle 12. The first interface 32 is adapted to selectively receive power from the external power source, such as from a power cable connected to the external power source, and then distribute the power to the battery pack 24 for charging the cells. One example external power source is an electrified vehicle charging station 60 (FIGS. 2, 4), such as a publically available electrified vehicle charging station. In another example, the electrified vehicle charging station is private, such as those at homes or businesses.

The charging system 30 may also be equipped with power electronics used to convert AC power received from the external power supply to DC power for charging the cells of the battery pack 24. The charging system 30 may also accommodate one or more conventional voltage sources from the external power supply (e.g., 110 volt, 220 volt, etc.).

The electrified vehicle 12, in this example, is outfitted and equipped to transport an electric wheelchair 40. The electric wheelchair 40 includes, among other things, an energy storage device, which in this example is a battery pack 42 including one or more arrays of battery cells. The electric wheelchair 40 further includes a motor 44 configured to drive the electric wheelchair 40. The motor 44 is powered by the battery pack 42. The electric wheelchair 40 is electrically coupled to the battery pack 24 of the electrified vehicle 12, in this example, by a second interface 46. The second interface 46 may include a plug and corresponding port. As will be discussed in more detail below, the battery pack 42 of the electric wheelchair 40 is configured to be charged directly by an electrified vehicle charging station or indirectly by way of the battery pack 24.

The electrified vehicle 12 further includes a controller 50, which may be programmed with executable instructions for interfacing with and operating the various components of the electrified vehicle 12 and the electric wheelchair 40. The controller 50 includes various inputs and outputs for interfacing with the components of the electrified vehicle 12 and the electric wheelchair 40. The controller 50 additionally includes a processing unit and non-transitory memory for executing the various control strategies and modes of the electrified vehicle 12 and the electric wheelchair 40.

The powertrain 10 and electric wheelchair 40 shown in FIG. 1 is highly schematic and is not intended to limit this disclosure. Various additional components could alternatively or additionally be employed within the scope of this disclosure.

FIG. 2 illustrates an electrified vehicle 12 outfitted and equipped to store and transport an electric wheelchair 40. In this example, the electrified vehicle 12 is a conversion van. The conversion van is a plug-in electrified vehicle, such as a BEV or PHEV. Again, this disclosure is not limited to any particular type of electrified vehicle.

As shown in FIG. 2, the electrified vehicle 12 includes a rear portion 52 configured to support the electric wheelchair 40. Specifically, the rear portion 52 of the electrified vehicle 12 includes a wheelchair support provided by a lift 54 and a lock 56. The lift 54 is operable to raise and lower the electric wheelchair 40 between the rear portion 52 and a ground surface 58. The lock 56 is configured to selectively hold the electric wheelchair 40 in place during storage, transport, and charging. At least a portion of the second interface 46 may be incorporated into the wheelchair support.

The electrified vehicle 12 is configured to be charged from an electrified vehicle charging station 60 (“charging station 60”), either directly or indirectly via the battery pack 24. The charging station 60 includes a tether-type charger assembly 62 and is coupled to an electrical grid 64, which is a grid power source. The charger assembly 62 conveys power from the electrical grid 64 to the electrified vehicle 12. In this example, the charger assembly 62 includes a terminal 66, a plug 68, and charger cable 70 between the terminal 66 and the plug 68. The plug 68 may have a standard plug configuration corresponding to that of the first interface 32, such as an SAE J1772 charge coupler configuration.

Charging the electrified vehicle 12 using the charging station 60 involves positioning the electrified vehicle 12 near the charging station 60 and electrically coupling the plug 68 to the electrified vehicle 12 via the first interface 32. Power can then move from the electrical grid 64 to the electrified vehicle 12, and specifically battery pack 24. The battery pack 24 can be charged when the electrified vehicle 12 is in the charging position.

When the electrified vehicle 12 is coupled to the charging station 60, the electric wheelchair 40 can also be charged with power from another charging station via the battery pack 24. The other charging station would be arranged substantially similar to the charging station 60. If the controller 50 determines that the state of charge (SOC) of the battery pack 42 of the electric wheelchair 40 is below a predetermined minimum threshold, for example, the controller 50 is operable to send instructions to various components of the electrified vehicle 12 such that power from the battery pack 24 is used to charge the battery pack 42. The battery packs 24 and 42 can thus be charged simultaneously.

Further, the battery pack 42 of the electric wheelchair 40 can be charged at times when the electrified vehicle 12 is not coupled to the charging station 60. When the SOC of the battery pack 24 exceeds a predetermined threshold, for example, the controller 50 is operable to send instructions to various components of the electrified vehicle 12 such that power from the battery pack 24 is used to charge the battery pack 42. Thus, the battery pack 24 can be selectively drained in order to charge the battery pack 42. Thus, the electrified vehicle 12 serves as a remote charging station when away from the charging station 60.

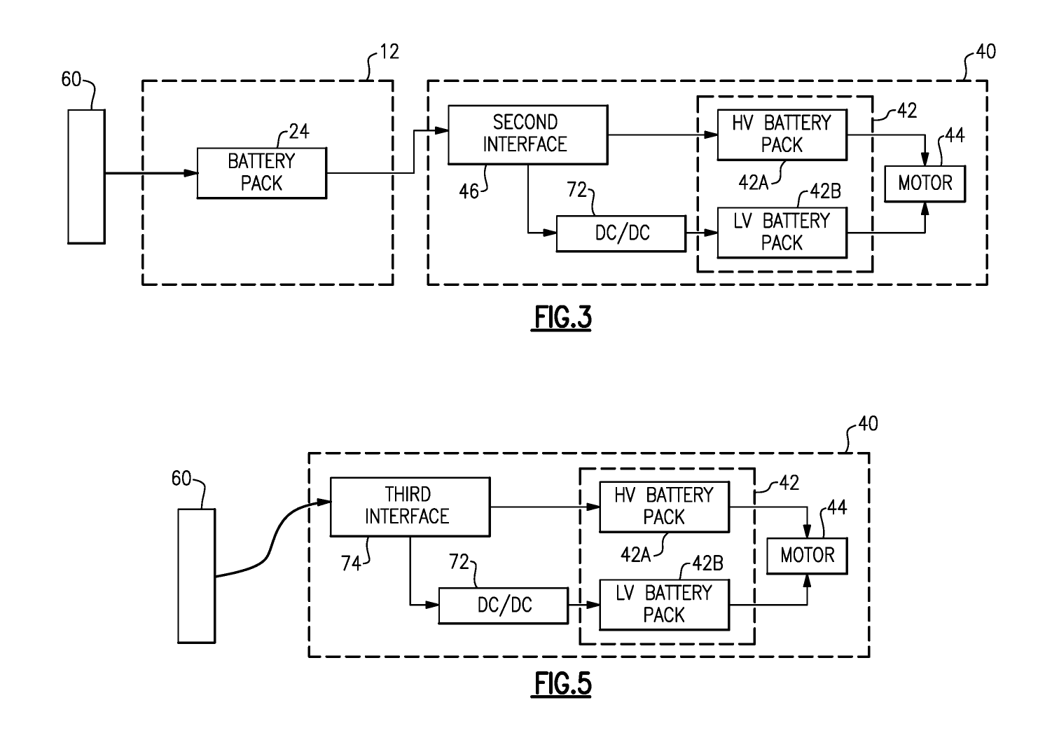

FIG. 3 schematically illustrates the arrangement between the charging station 60, the electrified vehicle 12, and the electric wheelchair 40. The battery pack 42 of the electric wheelchair 40 can be either a low or high voltage battery pack. The two different battery packs are represented at block 42 in FIG. 3, one of which is a high voltage battery pack 42A and the other of which is a low voltage battery pack 42B.

When the battery pack 42 is a high voltage battery pack 42A, the high voltage battery pack 42A is directly coupled to the battery pack 24 by way of the second interface 46. The high voltage battery pack 42A may provide a voltage substantially the same as that of the battery pack 24. In one example, the high voltage battery pack 42A provides a voltage of about 350 Volts (DC). In other examples, the high voltage battery pack 42A provides a voltage between 250-1,000 Volts (DC).

When the battery pack 42 is a low voltage battery pack 42B, the low voltage battery pack 42B is coupled to the second interface 46 indirectly via a DC-to-DC converter 72. The low voltage battery pack 42B provides a voltage of about 60 Volts (DC) in one example, which is substantially less than the voltage provided by the battery pack 24. The DC-to-DC converter 72 is configured to convert direct current from the battery pack 24 from one voltage level to another. In this example, the relatively high voltage (e.g., 350 Volts) provided by the battery pack 24 is converted to a voltage that is relatively low (e.g., 60 Volts) and capable of charging the low voltage battery pack 42B.

While FIGS. 2 and 3 show and describe the charging station 60 charging the electric wheelchair 40 indirectly via the battery pack 24, the electric wheelchair 40 is also capable of being charged directly by the charging station 60. With reference to FIG. 4, the electric wheelchair 40 includes a third interface 74 configured to directly couple to the plug 68. Thus, the electric wheelchair 40 can be charged by the charging station 60, whether the electric wheelchair 40 is in the electrified vehicle 12 or not, which increases convenience for the wheelchair operator. Since the charging stations 60 are typically found in public places, allowing the operator to charge the electric wheelchair 40 when away from their home or office, as examples, relieves range anxiety and improves quality of life. Further, since many charging stations 60 are configured to relatively rapidly charge electrified vehicles, the electric wheelchair 40 can be charged relatively quickly.

FIG. 5 schematically illustrates the arrangement between the charging station 60 and the electric wheelchair 40. In FIG. 5, the battery pack of the electric wheelchair 40 is represented at block 42. In one example, the battery pack 42 is a high voltage battery pack 42A. Alternatively, the battery pack 42 is a low voltage battery pack 42B. In the embodiment where the battery pack 42 is a low voltage battery pack 42B, the electric wheelchair 40 includes a DC-to-DC converter 72 between the third interface 74 and the low voltage battery pack 42B. The DC-to-DC converter 72 serves the same function as in the embodiment of FIG. 3, in that it converts relatively high voltage current from the charging station 60 to relatively low voltage to charge the low voltage battery pack 42B. When the electric wheelchair 40 includes a high voltage battery pack 42A, there is no DC-to-DC converter.

While shown separately, it should be understood that the electric wheelchair 40 could include one or both of the interfaces 46, 74. Further, the third interface 74 could be provided by the same structure as the second interface 46 or, alternatively, the second and third interfaces 46, 74 could be separate structures. In this way, the electric wheelchair 40 can be charged using power from the battery pack 24 and/or the charging station 60. It should also be understood that the electric wheelchair 40 could be charged using power from a first charging station simultaneous with the electrified vehicle 12 being charged using power from a separate, second charging station. In that case, when multiple power sources are available, the controller 50 may be configured to determine the most efficient way to charge the electric wheelchair 40, and to direct power to the battery pack 42 accordingly.

It should be understood that terms such as “about” and “substantially” are not intended to be boundaryless terms, and should be interpreted consistent with the way one skilled in the art would interpret those terms.

Although the different examples have the specific components shown in the illustrations, embodiments of this disclosure are not limited to those particular combinations. It is possible to use some of the components or features from one of the examples in combination with features or components from another one of the examples.

One of ordinary skill in this art would understand that the above-described embodiments are exemplary and non-limiting. That is, modifications of this disclosure would come within the scope of the claims. Accordingly, the following claims should be studied to determine their true scope and content.

1. A method of charging an electric wheelchair, comprising:
charging an energy storage device of the electric wheelchair with power from an electrified vehicle charging station.

2. The method as recited in claim 1, further comprising:
plugging a plug of the electrified vehicle charging station directly into an interface of the electric wheelchair, the interface coupled to the energy storage device of the electric wheelchair.

3. The method as recited in claim 2, further comprising:
plugging a plug of another electrified vehicle charging station into an interface coupled to an energy storage device of an electrified vehicle, the electric wheelchair located within the electrified vehicle.

4. The method as recited in claim 3, further comprising:
charging the energy storage devices of the electric wheelchair and the electrified vehicle simultaneously.

5. The method as recited in claim 1, further comprising:
plugging a plug of the electrified vehicle charging station into an interface of an electrified vehicle; and
charging the energy storage device of the electric wheelchair using power from an energy storage device of the electrified vehicle.

6. The method as recited in claim 5, further comprising:
removing the plug of the electrified vehicle charging station from the interface of the electrified vehicle; and
charging the energy storage device of the electric wheelchair using power from the energy storage device of the electrified vehicle.

7. The method as recited in claim 5, wherein the electrified vehicle is a conversion van.

8. The method as recited in claim 1, wherein the energy storage device of the electric wheelchair is a high voltage battery pack.

9. The method as recited in claim 1, wherein the energy storage device of the electric wheelchair is a low voltage battery pack, and wherein the electric wheelchair includes a DC-to-DC converter.

10. The method as recited in claim 1, wherein the electrified vehicle charging station is publicly accessible.

11. The method as recited in claim 1, wherein the electrified vehicle charging station includes a plug coupled to a terminal by a cable.

12. The method as recited in claim 11, wherein the terminal is electrically coupled to an electrical grid.

13. An electrified vehicle, comprising:
an energy storage device;
a first interface configured to couple the energy storage device to a plug of an electrified vehicle charging station; and
a second interface configured to couple the energy storage device to an electric wheelchair.

14. The electrified vehicle as recited in claim 13, further comprising a wheelchair support in a rear portion of the electrified vehicle, the wheelchair support including a portion of the second interface.

15. The electrified vehicle as recited in claim 14, wherein the wheelchair support includes at least one of a lock and a lift.

16. The electrified vehicle as recited in claim 13, wherein the electrified vehicle is a conversion van.

17. An electric wheelchair, comprising:
a motor;
an energy storage device configured to power the motor; and
an interface configured to connect to a plug of an electrified vehicle charging station to charge the energy storage device.

18. The electric wheelchair as recited in claim 17, wherein the interface is a first interface, and further comprising a second interface configured to connect to an energy storage device of an electrified vehicle.

19. The electric wheelchair as recited in claim 17, wherein the energy storage device includes a low voltage battery pack, and wherein the electric wheelchair includes a DC-to-DC converter.

20. The electric wheelchair as recited in claim 17, wherein the energy storage device is a high voltage battery pack.
